(19) United States
(12) Patent Application Publication
(10) Pub. No.: US 2024/0179134 A1
(43) Pub. Date: May 30, 2024

(54) Selective Content Delivery

(71) Applicant: SmartFrame Technologies Limited, London (GB)

(72) Inventors: Artur Wisniewski, London (GB); Tomasz Borys, London (GB); Michal Pasternak, London (GB); Patrick Krupa, London (GB)

(21) Appl. No.: 18/552,012

(22) PCT Filed: Mar. 23, 2022
(86) PCT No.: PCT/GB2022/050734

§ 371 Date: Sep. 22, 2023

(30) Foreign Application Priority Data
Mar. 23, 2021 (GB) 2104062.1

(51) Int. Cl. H04L 9/40

(52) U.S. Cl. CPC H04L 63/0421; H04L 63/0876

(57) ABSTRACT

A method for determining whether to deliver a content item to a device for display in a display area of the device, the device comprising a communication interface, the method comprising: receiving a request message from the device, the request message being a request for a content item to be sent to the device, the request message comprising a device characteristic fingerprint and an interface address associated with the communication interface; performing an adjustment function on the interface address to form a modified interface address; forming an anonymised device identity by combining the device characteristic fingerprint with the modified interface address; storing the request for a content item against the anonymised device identity; determining whether a content item is available to the anonymised device identity based on a request frequency for the anonymised device identity; and sending a response message to the device, the response message indicating whether the content item is available for the anonymised device identity.

This invention relates to a method for determining whether to deliver a content item to a device for display in a display area of the device and a method for requesting a content item for display in a display area of a device.

It is common for items of content to be shared over computer networks and in particular the internet. Users will generally navigate to websites where those content items will be displayed. Alternatively, the content items may displayed within an application. The content items are generally media files. The content items may be image files, video files or audio files. The content items may be a combination of picture(s) either in the form of a static picture, a series of pictures or a video. The content items may combine some form of visual content, such as picture(s) and/or video, with audio content, such as speech or music.

It is important to ensure that the user does not receive too many content items in one viewing and/or that only a particular number of a type of content item are shown to a user within a given time period. This is because the user may have a fixed attention span and so showing the user content items beyond this attention span would mean that the content items would not be recognised or sufficiently viewed by the user. Additionally, if the content items are the same or similar within a given time period or screen area, again the user may not sufficiently interact with those content items. Therefore, it is useful to track which content items have been offered to a user and to control further delivery of content items to optimise a user's engagement with those content items.

It is becoming increasing common for restrictions to be put on how a user's interaction with a website or application can be logged by a remote party. The remote party may be the operator of a server that supplies content items to a user device. The restrictions have been put in place to protect the privacy of the user and mean that they need to consent if tracking by a third party could lead to a direct identification of the user in the future. A common method of tracking users in this way is the use of cookies which are small files that are stored on the user's device which can be accessed by servers when a user interacts with content on those servers. These can be used to track a user's interaction with content items and ensure that relevant content items are supplied to the user at the correct time. It is becoming increasingly difficult to use this method of tracking a user's interaction with content on servers due to applications blocking these cookies and also due to the user needing to consent to their use.

It would therefore be desirable for there to be an improved method of delivering content items to a user whilst protecting the user's privacy.

According to a first aspect of the present invention there is provided a method for determining whether to deliver a content item to a device for display in a display area of the device, the device comprising a communication interface, the method comprising: receiving a request message from the device, the request message being a request for a content item to be sent to the device, the request message comprising a device characteristic fingerprint and an interface address associated with the communication interface; performing an adjustment function on the interface address to form a modified interface address; forming an anonymised device identity by combining the device characteristic fingerprint with the modified interface address; storing the request for a content item against the anonymised device identity; determining whether a content item is available to the anonymised device identity based on a request frequency for the anonymised device identity; and sending a response message to the device, the response message indicating whether the content item is available for the anonymised device identity.

The interface address may be an identifier used by the communication interface to communicate over a network. The interface address may be associated with the communications interface as a result of the communication network that the communications interface communicates over. The adjustment function may change part of the interface address if the interface address matches a predefined adjustment condition.

The predefined adjustment condition may be that part of the interface address is an odd number and the adjustment function rounds the interface address to an even number. The predefined adjustment condition may be that part of the interface address is an even number and the adjustment function rounds the interface address to an odd number. The adjustment function may round part of the interface address to the nearest odd or even number.

Forming the anonymised device identity may comprise concatenating the device characteristic fingerprint with the modified interface address. Forming the anonymised device identity may comprise concatenating the device characteristic fingerprint with the modified interface address to form an intermediate device identity and applying a hash function to the intermediate device identity to form the anonymised device identity. The hash function may use a non-reversible algorithm.

The request message may comprise a site identifier; storing the request for a content item against the anonymised device identity may comprise storing a request frequency for respective site identifiers; and determining whether a content item is available to the anonymised device may be based on the request frequency for the site identifier. Storing the request for a content item against the anonymised device identity may comprise incrementing a first count of content items requested by the anonymised device identity; and determining whether a content item is available to the anonymised device identity may comprise determining that a content item is available to the anonymised device if the first count is divisible by a first limit value. Storing the request for a content item against the anonymised device identity may comprise incrementing a first count of content items requested by the anonymised device identity; and determining whether a content item is available to the anonymised device identity may comprise determining that a content item is not available to the anonymised device if the first count is not divisible by a first limit value. The method may comprise clearing the first count after a first predetermined time period.

The request message may comprise a site identifier; storing the request for a content item against the anonymised device identity may comprise incrementing a second count of content items requested by the anonymised device identity and from the site identifier; and determining whether a content item is available to the anonymised device identity may comprise determining that a content item is available to the anonymised device if the second count is less than or equal to a second limit value. The request message may comprise a site identifier; storing the request for a content item against the anonymised device identity may comprise incrementing a second count of content items requested by the anonymised device identity and from the site identifier; and determining whether a content item is available to the anonymised device identity may comprise determining that a content item is not available to the anonymised device if the second count is greater than a second limit value. The method may comprise clearing the second count after a second predetermined time period if the second count has not been updated within the second predetermined time period.

The request message may comprise a site identifier; storing the request for a content item against the anonymised device identity may comprise incrementing a third count of content items requested by the anonymised device identity and from the site identifier; and determining whether a content item is available to the anonymised device identity may comprise determining that a content item is available to the anonymised device if the third count is less than or equal to a third limit value. The request message may comprise a site identifier; storing the request for a content item against the anonymised device identity may comprise incrementing a third count of content items requested by the anonymised device identity and from the site identifier; and determining whether a content item is available to the anonymised device identity may comprise determining that a content item is not available to the anonymised device if the third count is greater than a third limit value. The method may comprise clearing the third count after a third predetermined time period. Determining whether a content item is available to the anonymised device identity may comprise determining that a content item is not available to the anonymised device if either (i) the second count is greater than the second limit value or (ii) the third count is greater than the third limit value.

The method may comprise providing browser executable code to the device which causes the device to execute the methods described herein.

According to a second aspect of the present invention there is provided method for requesting a content item for display in a display area of a device, the device comprising a communication interface, the method comprising: loading a plurality of device characteristics of the device; forming a device characteristic fingerprint by combining the plurality of device characteristics; sending a request message to a server, the request message being a request for a content item to be sent to the device and the request message comprising the device characteristic fingerprint; and receiving a response message from the server indicating whether the content item is available for an anonymised device identity formed from the device characteristic fingerprint and an interface address associated with the communication interface.

The device characteristics may comprise at least one physical characteristic of the device. The device characteristics may comprise a plurality of physical characteristics of the device. The device characteristics may comprise least one software characteristic of the device. The device characteristics may comprise a plurality of software characteristics of the device. The device characteristics may be characteristics that the device represents as having. Forming a device characteristic fingerprint may comprise concatenating the plurality of device characteristics. Forming a device characteristic fingerprint may comprise concatenating the plurality of device characteristics to form an intermediate combined characteristic and applying a hash function to the intermediate combined characteristic to form the device characteristic fingerprint. The request message may comprise a site identifier.

The response message may comprise information that enables the device to receive the content item if the content item is available. The response message may comprise the content item if the content item is available for the anonymised device identity. The response message may comprise an identifier to enable the device to retrieve the content item if the content item is available for the anonymised device identity. The response message may state that no content item is available for the anonymised device identity.

The present invention will now be described by way of example with reference to the accompanying drawings. In the drawings:

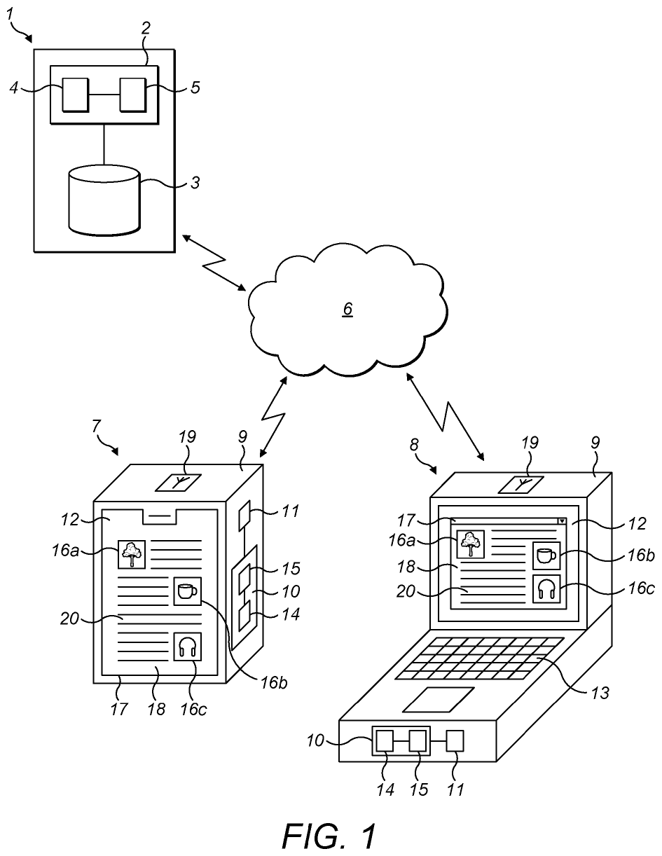

FIG. 1 shows an example system that implements the method described herein.

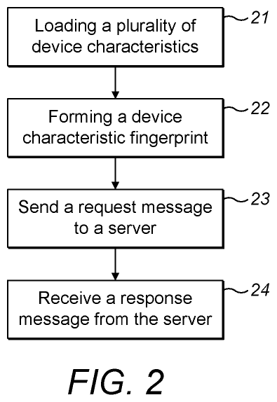

FIG. 2 shows a flow diagram of a method for requesting a content item for display in a display area.

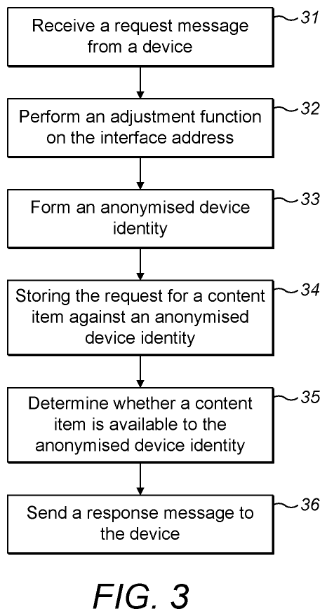

FIG. 3 shows a flow diagram of a method for determining whether a content item is available for an anonymised device identity.

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The present invention relates to a method for determining whether to deliver a content item to a device for display in a display area of the device, the device comprising a communication interface. The method comprises receiving a request message from the device, the request message being a request for a content item to be sent to the device, the request message comprising a device characteristic fingerprint and an interface address associated with the communication interface, performing an adjustment function on the interface address to form a modified interface address, and forming an anonymised device identity by combining the device characteristic fingerprint with the modified interface address. The method further comprises storing the request for a content item against the anonymised device identity, determining whether a content item is available to the anonymised device identity based on a request frequency for the anonymised device identity; and sending a response message to the device, the response message indicating whether the content item is available for the anonymised device identity.

The present invention also relates to a method for requesting a content item for display in a display area of a device, the device comprising a communication interface. The method comprising loading a plurality of device characteristics of the device, and forming a device characteristic fingerprint by combining the plurality of device characteristics. The method further comprises sending a request message to a server, the request message being a request for a content item to be sent to the device and the request message comprising the device characteristic fingerprint, and receiving a response message from the server indicating whether the content item is available for an anonymised device identity formed from the device characteristic fingerprint and an interface address associated with the communication interface.

FIG. 1 shows an example system that can permit the delivery and display of content items in a display area of a device. The system comprises a server 1. It will be appreciated that whilst reference may be made to a single server 1, this server could be part of a cluster of servers or may be a virtual server running in a cloud-based, virtual environment. The server comprises a processing section 2 and a storage section 3. The server 1 is configured to implement methods described herein for processing requests for content items and deciding whether to supply them to end-user devices. These methods can be implemented and controlled by the processing section 2. The processing section 2 could perform its methods using dedicated hardware, using a general purpose processor executing software code, or using a combination of the two. A processor 4 executes software code stored in a non-transient way in software memory 5 in order to perform its methods. The processing section can read/write data from/to storage location 3. The storage location 3 may be in the form of a memory. Storage location 3 may comprise non-volatile memory, may be in the form of an array of discrete banks of memory such as hard disks. Whilst shown in FIG. 1 as schematically being part of server 1, the storage location 3 may be separate to server 1 and connected to server 1. The above-described content items may be stored in storage location 3. The methods undertaken by server 1 may be spilt across multiple servers. For instance, a first server may receive the requests for content items and decide they should be supplied to an end-user device and a second server may store the content items and supply them to the end-user device.

The server 1 may be connected to a computer network 6 to permit the transmission of image files. Computer network 6 may be made up of many network segments that are connected together and so may be a large distributed network such as the internet or another public network.

Also connected to computer network 6 are a plurality of user terminals. User terminals may be a computer, such as a desktop or laptop computer; a portable device, such as a laptop, tablet computer or smartphone; or a smart TV or other device that can connect to remote servers using computer network 6 to access remote content located on servers such as server 1 to permit a user to send and receive information over computer network 6. In the example given in FIG. 1, two user terminals are shown, the first user device 7 being a smartphone 7 with the second user device 8 being a laptop 8. Typically, the user device 7, 8 will be located remote from the server 1 and may well be located in a different country or even on a different continent from the server 1.

As shown in FIG. 1, the first and second devices 7, 8 may comprise a housing 9. The first and second devices 7, 8 comprise a processing section 10 and a memory 11. The first and second devices comprise a user interface constituted by a display 12 and, shown in the case of second device 8, a series of user-actuable switches 13. The display and switches could be combined into a touchscreen device as shown by first device 7. The first and second devices 7, 8 may comprise a wireless communication interface 19 for communicating with computer network 6. The first and second devices 7, 8 may comprise a wired communication interface 19 for communicating with computer network 6.

The device 7, 8 may be configured to display content items on the screen. The first and second devices 7, 8 may be capable of implementing methods described herein to request content items and display those content items on display screen 12. These methods may be implemented and controlled by the processing section 10. The processing section 10 could perform its methods using dedicated hardware, using a general purpose processor executing software code, or using a combination of the two. A processor 14 executes software code stored in a non-transient way in software memory 15 in order to perform its methods. The processing section can read/write data from/to memory 11. The memory 11 may be a storage location for data. Memory 11 may comprise non-volatile memory, may be in the form of an array of discrete banks of memory such as hard disks. Whilst shown in FIG. 1 as schematically being part of first and second devices 7, 8, the memory 11 may be separate to first and second devices 7, 8 and respectively connected to first and second devices 7, 8 by some means.

In FIG. 1, user device 8 is shown displaying a plurality of content items 16a, 16b, and 16c within an internet browser window 17 using display 12. The user device may show one or more content items 16 within the internet browser window 17 using display 12. The internet browser window comprises a display area 18. The internet browser may use display area 18 for the display of webpages that have been accessed over the internet 6 or other computer network 6. The display area 18 may display content items 16. The content items may be a picture 16a, a series of pictures 16b shown one after another or a video 16c. The content items may also include audio. The display area 18 may display other media such as text 20. Those content items 16 may have been requested and received from server 1 over the communications network 6. Way in which those content items 16 are requested, the content items 16 that are displayed in the display area 18 and the way in which those content items 16 are displayed may be specified by code, stored on server 1, that may be interpreted by a user device 7, 8 to display those content items 16 on display area 18. The code may be in the form of a webpage. Such a webpage may be accessed by the internet browser 17. The code may be browser executable code. The code may be JavaScript.

First user device 7, analogously to second user device 8, is shown displaying three content items 16a, 16b and 16c together with other media such as text 20. In this case, the browser window 17 fills the display screen 12 of the first user device 7. The display area 18 therefore takes up most, if not all, of the space of display screen 12. The internet browser and display area operate in an analogous way to second user device 8.

Whilst traditionally internet browsers 17 may have been a separate application running on user device 7, 8, it will be appreciated that the term internet browser may encompass a part of another application that displays a webpage within that application. In this case the internet browser itself may be embodied by and/or be part of the other application. The area of the other application may then suitably be the display area 18 of the internet browser. In this way, another application may be capable of interpreting the code, stored on server 1, so as to display those content items 16 on display area 18. At least one of those content items may be an image file 16.

The improved method of requesting and displaying content items within the display area will now be described with reference to the figures.

FIG. 2 shows a flow diagram of the method by which a device sends a request for a content item to a server and receives a response to that request. The method may be implemented by the device receiving code which is then executed by the device to implement the method shown in FIG. 2 and described with reference to FIG. 2. The code may be stored on server 1, that may be interpreted by a user device 7, 8 to display those content items 16 on display area 18. The code may be in the form of a webpage. Such a webpage may be accessed by the internet browser 17. The code may be browser executable code. The code may be JavaScript.

As shown in 21, the method for requesting a content item for display in a display area of a device comprises loading a plurality of device characteristics associated with the device by the device. These device characteristics are properties of the device running the method. The device characteristics may be physical characteristics of the device, such as the screen pixel dimensions. The device characteristics may be software characteristics of the device, for example the properties of applications, such as the internet browser, running on the device.

The physical characteristics of the device may include:
Characteristics of the processor of the device. This may include one or more of: the number of logical processors available to run threads on the device, and the class of processor of the device.
Characteristics of the memory of the device. This may include the size of memory of the device. The memory may be volatile memory such as RAM.

The details of the memory of the device may provide a figure that is based on the memory present in the device.
Characteristics of the display of the device. This may include the maximum number simultaneous touch contact points on a display of the device. This may include the width of the display in pixels. This may include the height of the display in pixels.
Characteristics of the input devices of the device. The input devices may be audio and/or video input devices. The characteristics may include the number of input devices of the device. This may include the number of audio and/or video input devices of the device.

The software characteristics of the device may include:
Characteristics of an internet browser being used to run the method. This may include the brand of internet browser. This may include the version of internet browser. This may include whether an adblocker is enabled in the internet browser.
Characteristics of the operating system running on the device. This may include the platform of the operating system running on the device. This may include the version of the operating system running on the device.
Characteristics of optional features running on the device. This may include fonts available for use on the device. This may include the ability of the device to read particular file formats.

The device characteristics that are loaded may be what the device purports those characteristics to be. The device may represent as having certain underlying characteristics and present those as device characteristics. It will be appreciated however that the device may have similar or different underlying characteristics to those presented and able to be loaded as device characteristics. For instance, the device characteristic may represent that a particular internet browser is being used to run the method however the underlying browser running the method may match that loaded as the device characteristic or may be different to it. It is the device characteristics as loaded from the device that are used in further steps. The device characteristics may be loaded via one or more APIs made available by the device to gather the device characteristics.

As shown in 22, the method for requesting a content item comprises forming a device characteristic fingerprint from the device characteristics by the device. The method comprises forming a device characteristic fingerprint by combining the plurality of device characteristics that have been loaded. The device characteristics may each be formed of a string of characters. The characters may be letters, numbers or a combination of the two. The device characteristics may be concatenated to form one intermediate combined characteristic. The intermediate combined characteristic may be operated on by a hash function to reduce the length of the intermediate combined characteristics to form the device characteristic fingerprint. The intermediate combined characteristic may be converted to hexadecimal format to form the device characteristic fingerprint. The intermediate combined characteristic may be encoded into a format that comprises printable characters and numbers to form the device characteristic fingerprint. In this way, the intermediate combined characteristic can be converted from binary into printable characters and numbers to form the device characteristic fingerprint. The intermediate characteristic may be encoded using Base64 to form the device characteristic fingerprint.

As shown in 23, the device sends a request message to a server. The request message is a request for a content item to be sent to the device. The request message may not specify what content item is to be sent to the device. The request message may request that the server select a content item and send it to the device. The request message includes the device characteristic fingerprint. The request message requests for a content item to be sent to the device in dependence on the device characteristic fingerprint. The request message provides both a request for a content item to be sent to the device and the device characteristic fingerprint. The request message may include a site identifier. The site identifier identity a location on the internet that the device has accessed to run the method for requesting a content item. The site identifier may identify the domain of the site. The content item may be displayed within a display area of the device which is rendering a page of the site.

As shown in 24, the device receives a response message from the server. The response message indicates whether the content item is available for the device characteristic fingerprint sent to the server. The response message may include information that enables the device to receive the content item if the content item is available for the device characteristic fingerprint sent to the server. The response message may include the content item if the content item is available for the device characteristic fingerprint sent to the server. The response message may include an identifier to enable the device to retrieve the content item if the content item is available for the anonymised device identity. The server has determined that a content item is available based on the device characteristic fingerprint sent to the server. The server also determines that a content item is available based on the frequency with which an anonymised device identity which is associated with the device characteristic fingerprint has requested content items. The response message may state that no content item is available in response to the request. The anonymised device identity, whilst not enabling the server to identify the device directly, permits the server to log over time when and how often the device has requested content items and adjust their availability in response to this frequency. In this way, the method enables the device to have privacy in that the device cannot be directly identified by the server but at the same time permit controlled access to the content items. The way in which the server determines whether to permit access to a content item is explained with reference to FIG. 3.

FIG. 3 shows a method for determining whether a content item is available to a device. As shown at 31, the method comprises receiving a request message from the device at the server. The request message is a request for a content item to be sent to the device. The request message may not specify what content item is to be sent to the device. The request message may request that the server select a content item and send it to the device. The request message includes the device characteristic fingerprint. The request message requests for a content item to be sent to the device in dependence on the device characteristic fingerprint. The request message provides both a request for a content item to be sent to the device and the device characteristic fingerprint. The request message may include a site identifier. The site identifier identity a location on the internet that the device has accessed to run the method for requesting a content item. The site identifier may identify the domain of the site. The content item may be displayed within a display area of the device which is rendering a page of the site.

An interface address is associated with a communication interface of the device sending the request message. The interface address may be an identifier used by the communication interface to communicate over a network. The interface address may be a publicly available interface address that is associated with the device due to the communications network that the device is using to request a content item. For instance, the interface address may be an address associated with a network device that the device connects to access a wider communication network such as the internet. The interface address may be an IP address. The IP address may be an IPv4 address. The IP address may be an IPv6 address. In this way, the interface address may be an identifier that identifies the device at a network layer. The interface address associated with the communication interface may be different to the interface address that the communication interface itself uses to communicate with. This may occur when the communication interface uses a private interface address to access a network and a network device uses a public interface address to communication with a wider network on behalf of the device.

The request message includes the interface address associated with the communication interface of the device. The request message may include the interface address by virtue of the interface address being the address that the request is identified as being sent by. The request message may be in the form of a packet. The packet may include a payload which includes the request for a content item to be sent to the device and the device characteristic fingerprint. The packet may include a header which includes the interface address of the device.

As shown in 32, an adjustment function is performed on the interface address by the server to form a modified interface address. The adjustment function changes the interface address based on adjustment rules to form the modified interface address. This may result in the changing of part of the interface address. The interface address may be formed of multiple parts and one part of the interface address is adjusted to form the modified interface address. Each part of the interface address may be an octet. Each part of the interface address may be two octets or a hextet. The adjustment function may round the interface address to an even number. The adjustment function may round the interface address to an odd number. The interface address may be rounded up or down to the nearest even number. The interface address may be rounded up or down to the nearest odd number. The adjustment function may round part of the interface address to an even or odd number. Part of the interface address may be rounded up or down to the nearest even or odd number. The part of the interface address that is rounded may be at least some of the least significant bits of the interface address. The last octet or last hextet of the interface address may be rounded. In the case that the interface address already matches the output of the adjustment function then the modified interface address may be the same as the interface address.

As shown in 33, an anonymised device identity is formed by the server. The anonymised device identity is formed by combining the device characteristic fingerprint with the modified interface address. The device characteristic fingerprint may be combined with the modified interface address by concatenating the device characteristic fingerprint with the modified interface address. The concatenation of the device characteristic fingerprint with the modified interface address may form an intermediate device identity. Forming the anonymised device identity may comprise applying a hash function to the intermediate device identity to form the anonymised device identity. The hash function may reduce the length of the intermediate device identity. The hash function obscures the device characteristic fingerprint and the modified interface address. The hash function may be non-reversible. In this way, the hash function may use a non-reversible algorithm. Examples of non-reversible algorithms are MD5 or SHA-1.

As shown at 34, the method comprises storing the request for a content item against the anonymised device identity.

The storing of the request may take place by the server logging the number of requests by the anonymised device identity from a particular site identifier. In this way, the server can build up a log of the viewing history of the anonymised device identity. The determination whether a content item is available can then be based on this viewing history.

The storing of the request may take place by the server incrementing one or more counters associated with the anonymised device identity.

The server may increment a first count of content items requested by the anonymised device identity. The server may clear the first count after a first predetermined time period. The first predetermined time period may be each day, it may be each half day, it may be each period of hours. Preferably, the first predetermined time period is each day.

The server may increment a second count of content items requested by the anonymised device identity and from a particular site identifier. The server may clear the second count after a second predetermined time period if the second count has not been updated within the second predetermined time period. The second predetermined time period may be 1, 2, 3, 4, 5, 10, 15 minutes. Preferably, the second predetermined time period is 2 to 4 minutes and more preferable is 3 minutes.

The server may increment a third count of content items requested by the anonymised device identity and from a particular site identifier. The server may clear the third count after a third predetermined time period. The third predetermined time period may be each day, it may be each half day, it may be each period of hours. Preferably, the third predetermined time period is each day.

As shown at 35, the method comprises determining whether a content item is available to the anonymised device identity. The determining whether a content item is available to the anonymised device identity is based on a request frequency for the anonymised device identity.

The determining whether a content item is available to the anonymised device identity may be based on the frequency with which the device has accessed a particular site identifier.

The determining whether a content item is available to the anonymised device identity may be based on the one or more counts associated with the anonymised device identity. If the one or more counts are less than a respective limit value then a content item is determined to be available to the anonymised device identity.

The first count may be associated with a first limit value. When the first count is divisible by the first limit value then the server determines that a content item is available to the device. When the first count is not divisible by the first limit value then the server determines that a content item is not available to the device. The second count may be associated with a second limit value. When the second count is less than or equal to the second limit value then the server may determine that a content item is available to the device. The third count may be associated with a third limit value. When the third count is less than or equal to the third limit value then the server may determine that a content item is available to the device. If either of the second or third count are greater than their respective limit values, then the server may determine that a content item is not available to the device. If either of the second or third count are greater than their respective limit values, then the server may determine that a content item is not available to the device irrespective of the condition associated with the first count.

As shown at 36, the method comprises sending a response message to the device. The response message indicates whether the content item is available for the anonymised device identity based on the determination at 33. The response message may include information that enables the device to receive the content item if the content item is available for the anonymised device identity. The response message may include the content item if the content item is available for the anonymised device identity. The response message may include an identifier to enable the device to retrieve the content item if the content item is available for the anonymised device identity. The server has determined that a content item is available based on the anonymised device identity and the frequency with which the anonymised device identity has requested content items.

The server may supply code to the device which is then executed by the device to implement the method shown in FIG. 2 and described with reference to FIG. 2. The code may be stored on server 1, that may be interpreted by a user device 7, 8 to display those content items 16 on display area 18. The code may be in the form of a webpage. Such a webpage may be accessed by the internet browser 17. The code may be browser executable code. The code may be JavaScript.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for determining whether to deliver a content item to a device for display in a display area of the device, the device comprising a communication interface, the method comprising:
receiving a request message from the device, the request message being a request for a content item to be sent to the device, the request message comprising a device characteristic fingerprint and an interface address associated with the communication interface;
performing an adjustment function on the interface address to form a modified interface address;
forming an anonymised device identity by combining the device characteristic fingerprint with the modified interface address;
storing the request for a content item against the anonymised device identity;
determining whether a content item is available to the anonymised device identity based on a request frequency for the anonymised device identity; and
sending a response message to the device, the response message indicating whether the content item is available for the anonymised device identity.

2. A method according to claim 1, wherein the interface address is an identifier used by the communication interface to communicate over a network.

3. A method according to claim 1, wherein the interface address is associated with the communications interface as a result of the communication network that the communications interface communicates over.

4. A method according to claim 1, wherein the adjustment function changes part of the interface address if the interface address matches a predefined adjustment condition.

5. A method according to claim 4, wherein the predefined adjustment condition is that part of the interface address is an odd number and the adjustment function rounds the interface address to an even number or part of the interface address is an even number and the adjustment function rounds the interface address to an odd number.

6. (canceled)

7. (canceled)

8. (canceled)

9. A method according to claim 1, wherein forming the anonymised device identity comprises concatenating the device characteristic fingerprint with the modified interface address to form an intermediate device identity and applying a hash function to the intermediate device identity to form the anonymised device identity.

10. A method according to claim 9, wherein the hash function uses a non-reversible algorithm.

11. A method according to claim 1, wherein the request message comprises a site identifier; storing the request for a content item against the anonymised device identity comprises storing a request frequency for respective site identifiers; and determining whether a content item is available to the anonymised device is based on the request frequency for the site identifier.

12. A method according to claim 1, wherein storing the request for a content item against the anonymised device identity comprises incrementing a first count of content items requested by the anonymised device identity; and determining whether a content item is available to the anonymised device identity comprises determining that a content item is available to the anonymised device if the first count is divisible by a first limit value or determining that a content item is not available to the anonymized device if the first count is not divisible by a first limit value.

13. (canceled)

14. A method according to claim 12, the method comprising clearing the first count after a first predetermined time period.

15. A method according to claim 1, wherein the request message comprises a site identifier; storing the request for a content item against the anonymised device identity comprises incrementing a second count of content items requested by the anonymised device identity and from the site identifier; and determining whether a content item is available to the anonymised device identity comprises determining that a content item is available to the anonymised device if the second count is less than or equal to a second limit value or determining that a content item is not available to the anonymized device if the second count is greater than a second limit value.

16. (canceled)

17. (canceled)

18. A method according to claim 1, wherein the request message comprises a site identifier; storing the request for a content item against the anonymised device identity comprises incrementing a third count of content items requested by the anonymised device identity and from the site identifier; and determining whether a content item is available to the anonymised device identity comprises determining that a content item is available to the anonymised device if the third count is less than or equal to a third limit value or determining that a content item is not available to the anonymised device if the first count is not divisible by a first limit value.

19. (canceled)

20. (canceled)

21. A method according to claim 18, wherein determining whether a content item is available to the anonymised device identity comprises determining that a content item is not available to the anonymised device if either (i) the second count is greater than the second limit value or (ii) the third count is greater than the third limit value.

22. (canceled)

23. A method for requesting a content item for display in a display area of a device, the device comprising a communication interface, the method comprising:
loading a plurality of device characteristics of the device;
forming a device characteristic fingerprint by combining the plurality of device characteristics;
sending a request message to a server, the request message being a request for a content item to be sent to the device and the request message comprising the device characteristic fingerprint; and
receiving a response message from the server indicating whether the content item is available for an anonymised device identity formed from the device characteristic fingerprint and an interface address associated with the communication interface.

24. A method according to claim 23, wherein the device characteristics comprise at least one physical characteristic of the device.

25. (canceled)

26. A method according to claim 23, wherein the device characteristics comprise at least one software characteristic of the device.

27. (canceled)

28. (canceled)

29. (canceled)

30. A method according to claim 23, wherein forming a device characteristic fingerprint comprises concatenating the plurality of device characteristics to form an intermediate combined characteristic and applying a hash function to the intermediate combined characteristic to form the device characteristic fingerprint.

31. A method according to claim 23, wherein the request message comprises a site identifier.

32. A method according to claim 1, wherein the response message comprises information that enables the device to receive the content item if the content item is available.

33. A method according to claim 1, wherein the response message comprises the content item or an identifier to enable the device to retrieve the content item if the content item is available for the anonymised device identity.

34. (canceled)

35. (canceled)
